(19) United States
(12) Patent Application Publication
(10) Pub. No.: US 2010/0155657 A1
(43) Pub. Date: Jun. 24, 2010

(54) AQUEOUS COMPOSITION CONTAINING FLUORINATED SULFONAMIDE AND SULFONAMIDATE COMPOUNDS

(75) Inventor: Patricia M. Savu, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/625,720

(22) Filed: Nov. 25, 2009

Related U.S. Application Data
(60) Provisional application No. 61/140,112, filed on Dec. 23, 2008.

(51) Int. Cl. C09K 3/00

(52) U.S. Cl. 252/182.3

(57) ABSTRACT

An aqueous composition comprises:
water;
a sulfonamide represented by

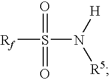

and
a sulfonamidate salt represented by

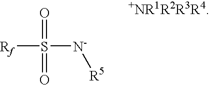

R_{f} represents a perfluoroalkyl group having from 1 to 12 carbon atoms. Each of R¹, R², R³, and R⁴ independently represents H or an alkyl group having from 1 to 6 carbon atoms. R⁵ represents H, an alkyl group having from 1 to 6 carbon atoms, or a hydroxyalkyl group having from 1 to 6 carbon atoms. The sulfonamide and the sulfonamidate salt are present in a respective mole ratio in a range of from 10:90 to 90:10.

### CROSS-REFERENCE TO RELATED APPLICATION

This application claims the benefit of U.S. Provisional Patent Application No. 61/140,112, filed Dec. 23, 2008, the disclosure of which is incorporated by reference herein in its entirety.

### TECHNICAL FIELD

The present disclosure relates broadly to aqueous compositions containing fluorinated surfactants.

### BACKGROUND

Surfactants are commonly included in aqueous compositions to reduce surface tension and improve wetting performance of the composition. Surfactants can be classified by type; for example, anionic, cationic, nonionic, or zwitterionic. Certain fluorinated compounds are widely used as surfactants in aqueous and non-aqueous compositions. For example, some fluorinated sulfonamides such as, e.g., CF₃CF₂CF₂CF₂SO₂NHCH₂CH₂OH and CF₃CF₂CF₂CF₂SO₂NH₂ can be readily deprotonated to form anionic surfactants (e.g., using aqueous ammonium hydroxide). If not sufficiently alkaline, aqueous solutions of such fluorinated surfactants may contain a mixture of significant amounts of neutral and anionic forms of the fluorinated surfactants.

Chemical reactions such as those used to prepare surfactants frequently result in crude reaction products that contain various components such as, for example, unreacted starting materials, isomers, and side products. An example is illustrated by the following reaction scheme (corresponding to the disclosure in col. 7, lines 29-63 of U.S. Pat. No. 7,169,323 (Parent et al.)).

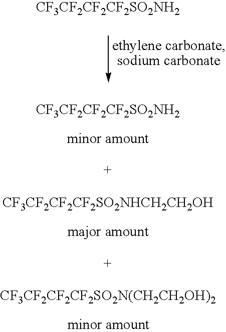

wherein hydroxyalkylation of nonafluorobutylsulfonamide in the presence of ethylene carbonate and sodium carbonate results in a mixture containing a major amount of the monoadduct CF₃CF₂CF₂CF₂SO₂NHCH₂CH₂OH, and minor amounts of unreacted starting material CF₃CF₂CF₂CF₂SO₂NH₂ and the diadduct CF₃CF₂CF₂CF₂SO₂N(CH₂CH₂OH)₂ Typically, purification is carried out to enrich the amount of, or isolate, a desired product before subsequent use, although it is also known to use some reaction mixtures without purification for some applications.

### SUMMARY

In one aspect, the present disclosure provides an aqueous composition comprising:

water;

a sulfonamide represented by

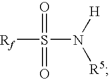

and

a sulfonamidate salt represented by

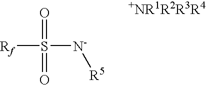

wherein
R_{f} represents a perfluoroalkyl group having from 1 to 12 carbon atoms;
each of R¹, R², R³, and R⁴ independently represents H or an alkyl group having from 1 to 6 carbon atoms; and
R⁵ represents H, an alkyl group having from 1 to 6 carbon atoms, or a hydroxyalkyl group having from 1 to 6 carbon atoms, and wherein the sulfonamide and the sulfonamidate salt are present in a respective mole ratio in a range of from 10:90 to 90:10.

In some embodiments, the aqueous composition is essentially free of halide ions. In some embodiments, the sulfonamide and the sulfonamidate salt are present in a respective mole ratio in a range of from 20:80 to 80:20. In some embodiments, the sulfonamide and the sulfonamidate salt are present in a respective mole ratio in a range of from 30:70 to 70:30. In some embodiments, each of R¹, R², R³, and R⁴ is independently H or a methyl group. In some embodiments, R⁵ is a hydroxyalkyl group. In some embodiments, R⁵ has from 2 to 5 carbon atoms. In some embodiments, R_{f} has from 3 to 5 carbon atoms. In some embodiments, the sulfonamide and the sulfonamidate salt collectively comprise at least 10 percent by weight of the aqueous composition. In some embodiments, the sulfonamide and the sulfonamidate salt are collectively present in the aqueous composition in an amount of from 100 to 10,000 parts per million by weight of the aqueous composition. In some embodiments, the aqueous composition further comprises water-soluble organic solvent.

In another aspect, the present disclosure provides a method of making an aqueous composition, the method comprising combining with water:

at least one base selected from the group consisting of:
compounds represented by the formula

NR¹R²R³
compounds represented by the formula

NR¹R²R³R⁴(OH), and
combinations thereof, wherein each of R¹, R², R³, and R⁴ independently represents H or an alkyl group having from 1 to 6 carbon atoms; and

a sulfonamide represented by the formula

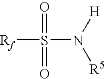

wherein R_{f} represents a perfluoroalkyl group having from 1 to 12 carbon atoms; and
R⁵ represents H, an alkyl group having from 1 to 6 carbon atoms, or a hydroxyalkyl group having from 1 to 6 carbon atoms, and wherein the sulfonamide and the sulfonamidate salt are present in a respective mole ratio in a range of from 10:90 to 90:10; and
   wherein the base and the sulfonamide are present in a respective ratio of from 10:90 to 45:55, wherein the aqueous composition is essentially free of halide ions.

Advantageously, Applicants have discovered that, in at least some cases, surface tension in water may be reduced beyond that achieved by fluorinated sulfonamidate anionic surfactants alone by combining the fluorinated sulfonamidate anionic surfactant with a substantial amount of fluorinated sulfonamide nonionic surfactant.

As used herein:

the term “deionized water” refers to water having electrical resistance of at least 10 megohm-centimeter;

the term “essentially free of halide ions” means containing not more than 100 parts per million of all halide ions combined;

the term “perfluoroalkyl group” refers to a fully fluorinated alkyl group such as, for example, CF₃—, CF₃CF₂—, CF₃CF₂CF₂—, (CF₃)₂CFCF₂CF(CF₃)CF₂—, or CF₃CF(CF₂CF₃)CF₂CF(CF₃)CF₂—.

In this application, whenever the presence of an ionic salt is indicated its presence is based on stoichiometric equivalent amounts of cationic and anionic constituent parts, which constituent parts may be present in dissociated or associated form.

### DETAILED DESCRIPTION

Aqueous compositions according to the present disclosure are first of all aqueous; that is they comprises substantial amounts of water. Typically, they comprise at least 20 percent by weight of water. More typically, they comprise at least 30, 40, 50, 60, 70, 80, 90, 99, or even at least 99.9 percent by weight of water, or more. Water-soluble organic solvents may be included in aqueous compositions according to the present disclosure; for example, in aqueous compositions having relatively lower water content. The remaining components of the aqueous compositions are typically dissolved or dispersed in the water and optional water-soluble organic solvent. Exemplary water-soluble organic solvents include ethers (e.g., tetrahydrofuran, p-dioxane, or diglyme), ketones (e.g., acetone), alcohols (e.g., methanol, ethanol, or isopropanol), and combinations thereof.

Aqueous compositions according to the present disclosure include a sulfonamide represented by the formula:

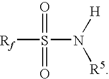

R_{f} represents a perfluoroalkyl group having from 1 to 12 carbon atoms. Examples include perfluorooctyl, perfluorododecyl, perfluorodecyl, perfluorohexyl, perfluoropentyl, and perfluorobutyl groups. Typically, R_{f} has from 3 to 5 carbon atoms. More typically, R_{f} is a perfluorobutyl group. R_{f} may be linear or branched, and may be cyclic or acyclic.

R⁵ represents H, an alkyl group having from 1 to 6 carbon atoms, or a hydroxyalkyl group having from 1 to 6 carbon atoms. Exemplary alkyl groups R⁵ include methyl, ethyl, propyl (e.g., 2-propyl or 1-propyl), butyl (e.g., 2-butyl or 1-butyl), pentyl, and hexyl groups. Exemplary hydroxyalkyl groups R⁵ include hydroxymethyl, 2-hydroxyethyl, 3-hydroxypropyl, 3-hydroxybutyl, 4-hydroxybutyl, 5-hydroxypentyl, and 6-hydroxyhexyl groups.

Aqueous compositions according to the present disclosure also include a sulfonamidate salt represented by formula:

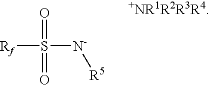

wherein R_{f} and R⁵ are as previously, and each of R¹, R², R³, and R⁴ independently represents H, or an alkyl group having from 1 to 6 carbon atoms. Exemplary groups R¹ to R⁴ include methyl, ethyl, propyl (e.g., 2-propyl or 1-propyl), butyl (e.g., 2-butyl or 1-butyl), pentyl, and hexyl groups.

Aqueous compositions according to the present disclosure may be essentially free of halide ions. This is typically desirable for applications in electronics fabrication.

Aqueous compositions according to the present disclosure may comprise additional non-halide components; however, those aqueous compositions that consist essentially of water, the sulfonamide, and the sulfonamidate salt are useful as aqueous rinses (i.e., without need for added optional components). Accordingly, the aqueous compositions may be used to rinse a surface of a substrate, which may comprise a chemically etched surface or an exposed and/or developed photoresist. Examples of substrates include glass, polysilicon, and metal (e.g., copper or aluminum). Aqueous compositions according to the present disclosure, when appropriately diluted are useful as a rinse for etched silicon wafers, or exposed and/or developed photoresists on silicon wafers, during semiconductor device fabrication, especially because they typically exhibit low surface tension at dilute concentration due to their low surface tension and extremely low halide ion content (especially fluoride).

Any amount of the sulfonamide and sulfonamidate salt may be used as long as the relative ratio discussed above is maintained. However, very small quantities of the sulfonamide and sulfonamidate salt are typically sufficient to substantially reduce the surface tension of the aqueous solution. Typically, concentrations of the sulfonamide and sulfonamidate, taken together, in a range of from 100 to 10,000 parts per million by weight (e.g., in a range of from 200 to 5,000 parts per million by weight) are effective to provide good wetting properties, although this is not a requirement. Alternatively, the aqueous composition may be provided in a concentrated form; for example, the sulfonamide and sulfonamidate salt may collectively comprise at least 5, 10, 15, 20, or even at least 25 percent by weight of the aqueous composition which may be diluted to concentrations of the sulfonamide and sulfonamidate taken together in a range of from 100 to 5000 parts per million.

The sulfonamide and sulfonamidate salts may be prepared according to procedures known to those in the fluorochemical arts; for example, analogously to the procedures in U.S. Pat. No. 7,169,323 (Parent et al.).

The pH of aqueous compositions according to the present disclosure is such that the sulfonamide and the sulfonamidate salt are present in a respective mole ratio in a range of from 10:90 to 90:10.

Objects and advantages of this disclosure are further illustrated by the following non-limiting examples, but the particular materials and amounts thereof recited in these examples, as well as other conditions and, details, should not be construed to unduly limit this disclosure.

### Examples

Unless otherwise noted, all parts, percentages, ratios, etc. in the Examples and the rest of the specification are by weight.

In the Examples, “centimeters” are abbreviated as “cm”, and “grams” are abbreviated as “g”.

In the Examples: “H-FBSA” refers to CF₃CF₂CF₂CF₂SO₂NH₂; “H-FBSE” refers to CF₃CF₂CF₂CF₂SO₂NHCH₂CH₂OH; and “Me-FBSA” refers to CF₃CF₂CF₂CF₂SO₂NHCH₃.

In the Examples, surface tensions were measured according to the method described in U.S. Pat. No. 7,169,323 (Parent et al.) at column 7, line 10.

The relative ratio of a sulfonamide and its corresponding sulfoamidate salt in solution depends of the Kₐ (commonly termed the “acid dissociation constant”) of the sulfonamide and the amount of base that is added. Kₐ is an equilibrium constant.

For an equilibrium between a generic acid (HA), and its conjugate base,

HA→H⁺+A⁻

Kₐ is defined as:

$${K}_{a} = \frac{[ {A}^{-} ] [ {H}^{+} ]}{[ HA ]}$$

wherein [HA], [A−] and [H+] respectively indicate concentrations of the generic acid, its conjugate base, and protons. Ka is a quantitative measure of the strength of an acid in solution: the larger the value the stronger the acid and the more the acid is dissociated, at a given concentration, into its conjugate base and hydrogen ion. The term pKₐ is defined as equal to −log Kₐ. Likewise, the term pH is defined as equal to −log [H⁺]. After rearranging the equation defining Kₐ (above) one obtains the equation:

pH=pKₐ−log([AH]/[A⁻])

Table 1 below reports the pKₐ values of various sulfonamides as determined experimentally, and the ratio of the sulfoamidate salt/sulfonamide (C₄F₉SO₂N⁽⁻⁾X/C₄F₉SO₂NHX) as calculated from the Henderson-Hasselbalch equation at various pH values.

TABLE 1

| | | C₄F₉SO₂N⁽⁻⁾X/C₄F₉SO₂NHX ratio | | | | |
|---|---|---|---|---|---|---|
| | | at Selected pH Values | | | | |
| C₄F₉SO₂NHX | pKₐ | 5 | 7 | 8.5 | 9 | 9.5 |
| X = H | 5.98 | 9.4/90.6 | 92.9/7.1 | 99.7/0.30 | 99.9/0.1 | 99.97/0.03 |
| X = | 6.57 | 2.7/97.4 | 72.9/27.1 | 98.8/0.20 | 99.6/0.3 | 99.88/0.12 |
| CH₂CH₂OH | | | | | | |
| X = CH₃ | 7.52 | 0.3/99.7 | 23.1/76.8 | 89.4/10.6 | 96.9/3.2 | 98.9/1.1 |
| X = CH₂CH₃ | 8.15 | 0.01/99.9 | 6.6/93.4 | 70.6/29.4 | 87.6/12.3 | 95.7/4.3 |

Starting with the neutral sulfonamide, and in order to achieve a pH of greater than 7, base needs to be added. The sulfonamide alone may not be sufficiently soluble in water to act as a surfactant. Accordingly, for aqueous compositions according to the present disclosure that include a sulfonamide with a pKₐ of less than 7.0, less than a stoichiometric amount of a base needs to be added for lowest surface tensions (e.g., ratios of A⁽⁻⁾/HA or C₄F₉SO₂N⁽⁻⁾X/C₄F₉SO₂NHX of less than 90/10).

The equilibrium between a sulfonamide and its conjugate sulfamidate anion is determined by the both the pKₐ of the sulfonamide and the pK_{b} (i.e., the pKₐ of the conjugate acid of the base). The equation below shows the deprotonation of a fluorinated sulfonamide with ammonia (a representative base).

NH₃+R_{f}SO₂NHX→NH₄⁺+R_{f}SO₂N⁽⁻⁾X

The neutralization equilibrium constant Kₙ can be expressed as

$${K}_{n} = \frac{[ {NH}_{4}^{+} ] [ {R}_{f} {SO}_{2} {N}^{( - )} X ]}{[ {NH}_{3} ] [ {R}_{f} {SO}_{2} NHX ]}$$

Kₙ can also be expressed as:

$${K}_{n} = \frac{{K}_{a} ( {R}_{f} {SO}_{2} NHX )}{{K}_{a} ( {NH}_{ 4}^{+} )}$$

Kₙ can be calculated since pKₐ=−log K_{a,} and the pKₐ for ammonium cation at 25° C. is known to be 9.24. Table 2 (below) reports calculated values of Kₙ for three representative sulfonamides.

TABLE 2
R_{f}SO₂NHX + NH₃ → R_{f}SO₂N⁽⁻⁾X + NH₄⁺

| | K_{(R}_{_{f}}_{SO}_{₂}_{NHX)} | Kₙ |
|---|---|---|
| C₄F₉SO₂NH⁻ (X = H) | 1.05 × 10⁻⁶ | 1800 |
| C₄F₉SO₂N⁽⁻⁾CH₂CH₂OH | 2.69 × 10⁻⁷ | 467 |
| (X = CH₂CH₂OH) | | |
| C₄F₉SO₂N⁽⁻⁾CH₃ (X = CH₃) | 3.01 × 10⁻⁸ | 52 |

The large values of the equilibrium constant in Table 2 show that if ammonia is added to a solution of these sulfonamides (or sulfonamides with a similar substitution pattern) it is essentially all converted to an ammonium salt of the sulfonamide until a stoichiometric amount of ammonia has been added.

Stock solutions were prepared in deionized water according to the compositions reported in Table 3 (below).

TABLE 3

| | grams | grams | grams | | grams of |
|---|---|---|---|---|---|
| | H- | H- | Me- | Counter | 30% NH₄OH, or |
| | FBSA | FBSE | FBSA | Ion | 25% N(CH₃)₄OH |
| Comparative | 0 | 20 | 0 | NH₄⁺ | 6.8 |
| Example A | | | | | |
| Comparative | 1 | 19 | 0 | NH₄⁺ | 6.8 |
| Example B | | | | | |
| Comparative | 1 | 19 | 0 | N(CH₃)₄⁺ | 21.1 |
| Example C | | | | | |
| Example1 | 20 | 0 | 0 | NH₄⁺ | 2 |
| Example 2 | 1 | 19 | 0 | NH₄⁺ | 2.2 |
| Example 3 | 0 | 100 | 0 | NH₄⁺ | 2 |
| Example 4 | 0 | 16 | 4 | NH₄⁺ | 2 |
| Example 5 | 3 | 17 | 0 | NH₄⁺ | 2 |
| Example 6 | 1.8 | 18.2 | 0 | NH₄⁺ | 2 |
| Example 7 | 1 | 19 | 0 | N(CH₃)₄⁺ | 10.8 |

Ammonium hydroxide (30%) or tetramethylammonium hydroxide (25%) (last columns of Table 3) were diluted with distilled water to make 60 g of base solution. The fluorochemical components were melted in an oven. To each base solution was added the indicated melted fluorochemicals, and then shaken until the solids had dissolved to give a total of 80 g of a solution at 25 percent fluorochemical content. These 25 percent fluorochemical content stock solutions were then further diluted with distilled water to 2000 ppm (Table 4) total fluorochemical content.

TABLE 4

| | Relative Percentages | | | Surface | |
|---|---|---|---|---|---|
| | H- | H- | Me- | tension, | Ratio of |
| | FBSA | FBSE | FBSA | dynes | sulfoamidate:sulfamide |
| Comparative | 0 | 100 | 0 | 61.8 | 100/0 |
| Example A | | | | | |
| Comparative | 5 | 95 | 0 | 54.2 | 100/0 |
| Example B | | | | | |
| Comparative | 5 | 95 | 0 | 37.3 | 100/0 |
| Example C | | | | | |
| Example 1 | 100 | 0 | 0 | 38.1 | 30/70 |
| Example 6 | 8.9 | 91.1 | 0 | 27.2 | 30/70 |
| Example 2 | 5 | 95 | 0 | 27.2 | 35/65 |
| Example 3 | 0 | 100 | 0 | 26.5 | 30/70 |
| Example 4 | 0 | 80 | 20 | 26.1 | 30/70 |
| | | | | | (not |
| | | | | | completely |
| | | | | | soluble) |
| Example 5 | 15 | 85 | 0 | 24.8 | 30/70 |
| Example 7 | 5 | 95 | 0 | 18.2 | 51/40 |

All patents and publications referred to herein are hereby incorporated by reference in their entirety. All numerical ranges in the specification and claims are inclusive of their endpoints unless otherwise indicated. Various modifications and alterations of this disclosure may be made by those skilled in the art without departing from the scope and spirit of this disclosure, and it should be understood that this disclosure is not to be unduly limited to the illustrative embodiments set forth herein.

What is claimed is:

1. An aqueous composition comprising:
water;
a sulfonamide represented by 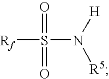
and
a sulfonamidate salt represented by 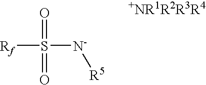
wherein
R_{f} represents a perfluoroalkyl group having from 1 to 12 carbon atoms;
each of R¹, R², R³, and R⁴ independently represents H or an alkyl group having from 1 to 6 carbon atoms; and
R⁵ represents H, an alkyl group having from 1 to 6 carbon atoms, or a hydroxyalkyl group having from 1 to 6 carbon atoms, and wherein the sulfonamide and the sulfonamidate salt are present in a respective mole ratio in a range of from 10:90 to 90:10.

2. The aqueous composition of claim 1, wherein the aqueous composition is essentially free of halide ions.

3. The aqueous composition of claim 1, wherein the sulfonamide and the sulfonamidate salt are present in a respective mole ratio in a range of from 20:80 to 80:20.

4. The aqueous composition of claim 1, wherein the sulfonamide and the sulfonamidate salt are present in a respective mole ratio in a range of from 30:70 to 70:30.

5. The aqueous composition of claim 1, wherein each of R¹, R², R³, and R⁴ is independently H or a methyl group.

6. The aqueous composition of claim 1, wherein R⁵ is a hydroxyalkyl group.

7. The aqueous composition of claim 6, wherein R⁵ has from 2 to 5 carbon atoms.

8. The aqueous composition of claim 1, wherein R_{f} has from 3 to 5 carbon atoms.

9. The aqueous composition of claim 1, wherein the sulfonamide and the sulfonamidate salt collectively comprise at least 10 percent by weight of the aqueous composition.

10. The aqueous composition of claim 1, wherein the sulfonamide and the sulfonamidate salt are collectively present in the aqueous composition in an amount of from 100 to 10,000 parts per million by weight of the aqueous composition.

11. The aqueous composition of claim 1, further comprising water-soluble organic solvent.

12. A method of making an aqueous composition, the method comprising combining with water:
at least one base selected from the group consisting of:
compounds represented by the formula
NR¹R²R³
compounds represented by the formula
NR¹R²R³R⁴(OH), and
combinations thereof, wherein each of R¹, R², R³, and R⁴ independently represents H or an alkyl group having from 1 to 6 carbon atoms; and
a sulfonamide represented by the formula 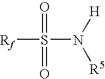
wherein R_{f} represents a perfluoroalkyl group having from 1 to 12 carbon atoms; and
R⁵ represents H, an alkyl group having from 1 to 6 carbon atoms, or a hydroxyalkyl group having from 1 to 6 carbon atoms, and wherein the sulfonamide and the sulfonamidate salt are present in a respective mole ratio in a range of from 10:90 to 90:10; and
wherein the base and the sulfonamide are present in a respective ratio of from 10:90 to 45:55, wherein the aqueous composition is essentially free of halide ions.
